(19) United States
(12) Patent Application Publication
(10) Pub. No.: US 2006/0225573 A1
(43) Pub. Date: Oct. 12, 2006

(54) Miniaturized enrichment facility

(76) Inventors: Jorg Muller, Buchholz (DE); Martin Sussiek, Hamburg (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/560,516

(22) PCT Filed: Jun. 24, 2004
(86) PCT No.: PCT/DE04/01328

§ 371 Date: Jun. 5, 2006

(30) Foreign Application Priority Data
Jun. 30, 2003 (DE) 103 29 535.6

(51) Int. Cl. B01D 53/02; B01D 53/14

(52) U.S. Cl. 96/107; 977/900

(57) ABSTRACT

The invention relates to a miniaturized facility for storing and/or enriching molecules and/or atoms, especially for us in a miniature gas-phase chromatograph, and to a method for producing such a miniaturized facility. The invention provides a facility which facilitates an effective sample enrichment in miniaturized analyses devices, especially miniature gas-phase chromatographs. The facility comprises a compartment (1) filled with a loading agent (2) that consists of carbon nanotubes and/or carbon nanofibers or contains the same. The facility can be easily produced by microsystem engineering methods and requires little energy. The invention also relates to a method for producing such an enrichment facility.

The invention relates to a miniaturized device for the storage and enrichment of molecules and atoms, especially for a miniaturized gas chromatograph, and a process for the production of such a miniaturized device. Further, the invention relates to the use of nano-scaled particles, tubes and/or fibers for the storage and/or enrichment of molecules and atoms for analytical purposes.

In order to lower the detection limits of analytical devices, a sample enrichment process is often carried out at the input of the analytical system, especially for gas analysis. With the help of such a sample enrichment the detection limit can be lowered by two to three orders of magnitude. In the classical analysis this is achieved via the so-called “Tenax” tubes. These tubes contain an organic polymer as an adsorbent for the enrichment of organic compounds. Also other substances, e.g. zeolites are used for this purpose. These filling substances consist of particles with a very porous surface topology. Therefore they exhibit an enlarged specific surface (m²/g) compared to particles with a homogenous surface structure and they have a very good storage capability for gaseous substances. In this way the adsorption of gas molecules at the surface is used for sample enrichment.

The available tubes are relatively voluminous and are therefore not suited to the overall concept of a miniaturized analysis system. Furthermore it is not possible to introduce adsorption material into such tubes with processes commonly used in microsystem technology.

From U.S. Pat. No. 6,004,450 a process for the production of a porous silicon membrane in a silicon substrate via microsystem technology is known. The silicon membrane can be used for the enrichment of sample material. The disadvantage of this process is that it only creates a porous structure within the silicon substrate used, and it is therefore not possible to adjust the surface energies via a choice of different materials or different material combinations. Furthermore, a subsequent homogenous coating of the silicon structures, especially in the vertical orientation, is not possible.

The object of the current invention is to provide a device that enables efficient sample enrichment for miniaturized analysis devices, especially miniature gas chromatographs, which can be easily produced using processes known within the microsystem technology, which has a low power consumption and which does not exhibit the disadvantages of the current state of the art devices described above. Furthermore, it is the object of the current invention to provide a process for the production of such a device.

The solution of the problem, according to the invention, is achieved by a device with the characteristics described in claim 1 as well as a process according to claim 17.

The device, according to the invention, for the storage and/or enrichment of molecules and/or atoms consists of a chamber with a filling material, the filling material consisting of or containing carbon nanotubes and/or carbon nanofibers.

Carbon nanotubes are well known (see for example: H. Hoffschulz, 2000, “Anwendungsperspektiven von Kohlenstoff-Nanorörchen”, Physikalische Blätter 56, 53-56). Carbon nanotubes were only discovered a few years ago and are described as carbon modifications with a tube-like shape. Carbon nanotubes belong to the nanoscale or nano-crystalline solids. Fullerenes (e.g. the “Buckminster Fullerene with 60 carbon atoms) also belong to this group, which represent essentially spherical carbon compounds. These solids are characterized by dimensions, which lie in the nanometer range (0.1-1000 nm). Carbon nanotubes, for example, have a diameter of e.g. 0.5 to 100 nm. In the case of nanotubes it can be distinguished between single wall nanotubes (SWNT) and multi wall nanotubes (MWNT). SWNT can have diameters between 0.5-1.5 nm, MWNT usually have much larger diameters e.g. 2-20 nm. The length of the tubes can hereby vary significantly. Currently, lengths from 0.5 nm to several micrometers are available. Carbon nanofibers are staples of small graphite layers, which also exhibit a high storage capacity.

Carbon nanotubes can be produced by Plasma Enhanced Chemical Vapor Deposition (PECVD). The plasma enhanced deposition of carbon nanotubes is known from a number of publications (see for example: Z. F. Ren et al., 1998, “Synthesis of large arrays of well aligned carbon nanotubes on glass”, Science 282, 1105-1107; M. Chhowalla et al., 2001, “Growth process conditions of chemical vapor deposition”, Journal of Applied Physics 90, 5308-5317; US 2002/0004136 (U.S. Pat. No. 6,361,861). These publications, incorporated herein by reference, describe the deposition of vertically orientated nanotubes onto substrates such as graphite, glass and silicon where, in general, metal catalysts are used.

The device according to the invention can be produced relatively simply with processes known within the microsystem technology. Such processes, which are known to a person skilled in the art, are for example structuring processes (lithography like deep x-ray-lithography and UV-lithography, Excimer laser structuring, mechanical micro-production, LIGA technology), thin film technology, doping, etch technology (wet etch processes such as immersions etching or spray etching, dry etch processes such as plasma etching, reactive ion etching (RIE) and ion beam etching) and the previously mentioned PECVD. The carbon nanotubes and/or carbon nanofibers can be deposited directly onto a suitable substrate or carrier, e.g. a silicon wafer. They exhibit a large specific surface and adsorb gas molecules. The characteristics of the carbon nanotubes and/or carbon nanofibers can be adjusted via appropriate deposition parameters during the PECVD process so that especially the surface energy of the filling material can be selectively adjusted.

The miniaturized device according to the invention exhibits a very low heat capacity. Therefore analysis systems can be realized, which, if required, can be cooled with low power consumption for sample enrichment, and can be heated with low power consumption for desorption of sample molecules. This is especially important for transportable analyzing devices where low power consumption is of importance.

Preferably the filling material of the device according to the invention is porous. It is however possible to insert substances (e.g. metals) into the inside of the tube in order to deliberately tune the adsorption characteristics.

The chamber of the device according to the invention is preferably located on a carrier or substrate. This carrier can be a glass or a metal, but is preferably a silicon wafer (Si wafer).

The chamber can be realized directly on the surface or on part of the surface of the carrier. It is also possible to embed the chamber into the surface of the carrier. For that case, channel like structures may be pre-defined in the silicon wafer and a layer of carbon nanotubes may be deposited at the bottom of these channels. In this way a very space efficient embodiment of the device according to the invention can be realized.

In an especially preferred embodiment of the invention the filling material is covered with at least one layer of amorphous carbon. In this way the chamber can be realized very simply. In this embodiment the walls of the chamber with the filling material are formed from the carrier and from the layer of amorphous carbon. The layer of amorphous carbon can also be deposited via Plasma Enhanced Chemical Vapor Deposition (PECVD).

An amorphous material is a substance where the atoms exhibit no order but where the atoms form random patterns. Materials with regular patterns are named crystals. The layer of amorphous carbon therefore consists of carbon atoms which do not form an ordered structure like for example carbon nanotubes.

In an embodiment of the invention a heating unit is provided, which is preferably located at one side or at a surface of the carrier opposite to the side or the surface of the carrier with the chamber. The heating unit can consist of a resistive heater implemented in thick-film or thin-film technology. The heating unit is provided to enable the deliberate release of adsorbed molecules or atoms. The heating unit can also be embedded into the carrier.

In an additional embodiment a cooling unit is provided which could be, for example, a Peltier element. Preferably the cooling unit is located opposite to the surface of the carrier with the chamber. Especially preferred, the cooling unit is located in a recess within the carrier so that the cooling unit is separated from the chamber only by a very thin-walled section of the carrier. In this way efficient cooling is possible at very low power consumption. The cooling unit can either be installed as an alternative or as an addition to the heating unit. Cooling can be advantageous in order to improve or facilitate the adsorption of sample molecules.

The chamber of the device according to the invention is preferably shaped like a channel. Preferably the chamber exhibits an inlet and an outlet for the delivery and extraction of a fluid, for example a sample of molecules or atoms that need to be analyzed. In this way a fluid stream, for example a gas stream with gas molecules that are to be analyzed, can be directed through the chamber with the filling material and the loading of the filling material with sample molecules is significantly improved.

In a preferred embodiment of the invention the outlet can be connected to the inlet of a separation column. This enables the direct connection of the device according to the invention to a separation column, which can also be realized using microsystem technology as known from DE 19726000 or DE 20301231. This is advantageous in order to minimize the amount of dead volume.

The current invention also relates to a process for the production of a miniaturized device for the storage and/or enrichment of molecules and or atoms, especially for a miniature gas chromatograph. In this process at least one layer of filling material consisting of or containing nanoscale particles, tubes and/or fibers is deposited on a carrier. Said at least one layer of filling material is preferably covered with at least one layer of amorphous material.

With the help of the process according to the invention a miniaturized device for the storage and/or enrichment of molecules and or atoms, especially for a miniature gas chromatograph can be realized in a very advantageous manner. For the production of miniaturized analysis systems especially adapted processes are required so that optimum results can be achieved and not only a compact design but also selectivity and analytical accuracy can be provided. The process according to the invention is particularly adapted to the demands of microsystem technology. The filling material consists of or contains nanoscale particles, tubes or fibers. Their dimensions, especially their diameter, are in the nanometer range (1 nm=10-9 m). Nanoscale particles are for example carbon nanotubes, carbon nanofibers and the previously mentioned Fullerenes. The C-60-Fullerene (a fullerene with 60 C-atoms, which has the form of a closed icosahedron, a polyeder that contains twelve pentagonal and 20 hexagonal segments), exhibits e.g. a diameter of approximately 0.7-1 nm. The carbon compounds exhibit a large storage capacity and physical-chemical resistance.

Preferably the filling material is covered by an amorphous layer of carbon. This is especially advantageous as such a layer can also be produced via plasma enhanced chemical vapor deposition under process conditions known to a person skilled in the art. It is therefore possible to produce the filling material(s) and the cover material(s) in one process step. Preferably the layers of filling material and amorphous material are deposited via PECVD.

In the process according to the invention, the section of the carrier, where the layer of filling material is deposited, is preferably determined by a catalyst layer which consists of a structured transition metal that has been deposited onto the carrier. The carrier preferably consists of a silicon wafer. The creation of carbon nanotubes is catalyzed by transition metals such as iron, cobalt or nickel. Chhowalla et al., 2001, Journal of Applied Physics 90, S.5308-5317 describe that nanoscale particles of the metal catalyst, which were produced via a sintering process of a metal catalyst layer, “ride” on the end of the growing nanotubes opposite to the carrier and catalyze their creation there. By adjusting the particle sizes of the metal catalyst it is therefore possible to influence the diameter of the formed nanotubes and therefore influence their physical-chemical properties. The carbon nanotubes grow preferably in the section of the carrier or carrier surface that is covered with the metal catalyst. The lateral dimension of the filling material on the carrier can be determined by depositing a metal catalyst layer in the desired area. The metal catalyst can be iron, nickel or cobalt. Other transition metals are also possible. A transition metal as used herein means an element of the groups 3-11 according to the IUPAC-classification (elements with atomic numbers 21-30, 39-48, 71-80, 103-112) as well as lanthanides (elements with atomic numbers 57-70) and actinides (elements with atomic numbers 89-102).

Alternatively, it is possible to define the area where the filling material is deposited with a lift-off technique, which is known to a person skilled in the art of microsystem technology. In this process the areas that should not contain any filling materials are covered with a sacrificial layer. Suitable sacrificial layers (e.g. SiO₂) are known to a person skilled in the art. The filling material layer(s) is (are) initially deposited onto sections that are covered with the sacrificial layer and sections that are free of the sacrificial layer. Subsequently the sacrificial layer can be removed via chemical processes so that the filling material only remains in the areas that have previously been free of the sacrificial layer.

In the process according to the invention the layer(s) of the filling material and the layer(s) of the amorphous material are preferably deposited onto the carrier in such a way that a channel is formed between the carrier and the layer of amorphous material, the channel containing the filling material. Preferably openings are introduced into the channel so that said channel can be connected to the outside world in order to connect to a separation column or sample application systems for example.

The invention also relates to the usage of nanoscale particles, tubes and/or fibers, especially carbon nanotubes or fullerenes for the storage and/or enrichment of molecules and/or atoms for the purpose of analysis of the molecules or atoms. Said molecules or atoms are preferably present in a fluid current, ideally a gas current.

The invention is described in the following section with the help of exemplary embodiments. It shows:

FIG. 1 An embodiment of the device according to the invention

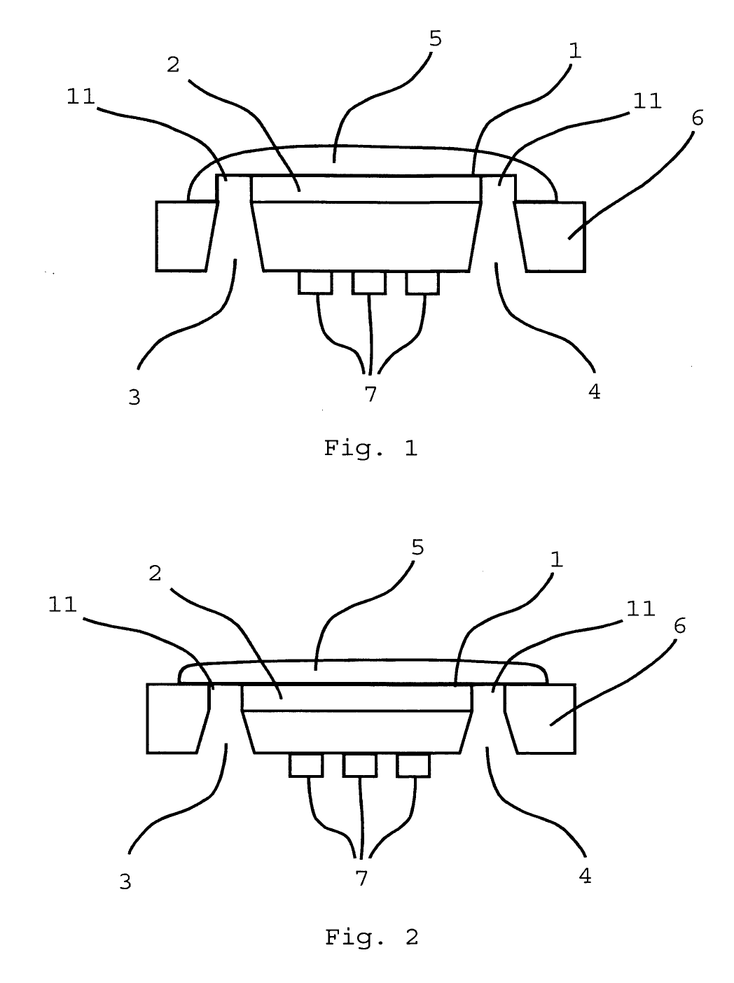

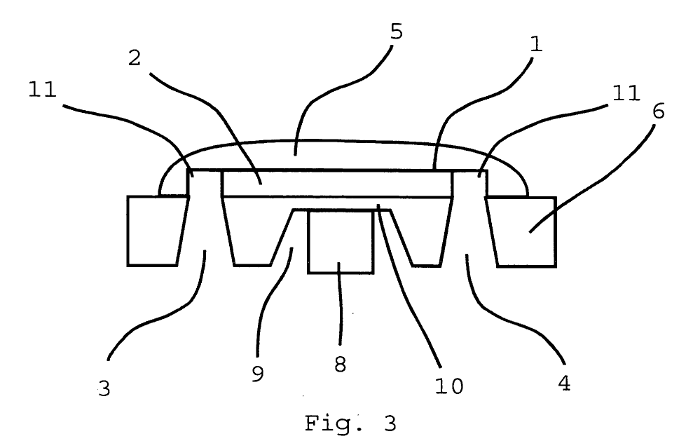

FIG. 2 An additional embodiment according to the invention

FIG. 3 A third embodiment according to the invention

FIG. 1 shows a device for the storage and/or enrichment of molecules and/or atoms according to the invention. The device is produced via microsystem technology. On the surface of the silicon wafer 6 a layer 2 of a filling material, which contains carbon nanotubes, is deposited using PECVD. The filling material layer 2 is covered by a layer 5, which consists of amorphous carbon, so that a channel like chamber 1 with the filling material 2 is formed. Two openings, an inlet 3 and an outlet 4, are incorporated in to the silicon wafer 6 using known processes from the microsystem technology. Via a connection 11 the openings are connected to the chamber 1. A fluid, for example a gas stream containing the gas molecules that need to be analyzed, can flow through the inlet 3, through the chamber 1 with the filling material and through the outlet 4 of the device. The sample molecules, which need to be analyzed, are adsorbed and enrichment by the filling material 2. At the side of the carrier 6, which lies opposite the side with the chamber 1, a heating unit 7 is present, for example thick-film or thin-film resistive heating elements. With the help of the heating unit 7 atoms and/or molecules, which have been adsorbed by the filling material 2, can be desorbed. A separation column can be connected to the outlet 4.

The silicon wafer 6 exhibits dimensions of the order of e.g. 5×3 mm, the chamber 1 with the filling material 2 is approximately 3 mm long and has a width and a depth of a few tenths of a millimeter.

For the production of the device a sacrificial layer consisting of organic material can be deposited in those areas of the carrier 6 (a Si-wafer), which shall form the connection 11. Subsequently, the layer of filling material 2 and a layer of amorphous carbon 5 are deposited via PECVD. From the other side, the inlet 3 and the outlet 4 are structured into the silicon wafer 6 via processes commonly known in microsystem technology. The sacrificial layer is subsequently either ashed or is dissolved using chemicals.

It is also possible to first structure the inlet 3 and the outlet 4 and to leave a thin Si-layer (Si-membrane) onto which the sacrificial layer is subsequently deposited. The Si-membrane and the sacrificial layer can be chemically removed after the layer of filling material 2 and the layer of amorphous material 5 have been deposited.

After structuring the inlet 3 and the outlet 4 it is also possible to insert a plug, consisting of a suitable material, into the openings on the side where the chamber 1 will be located, in such a way, that the area, which will form the connection 11, is not covered by the filling material 2. After the production of the chamber 1 with the filling material 2 the plug can be removed, for example via chemical means.

FIG. 2 shows a device according to the invention, where the channel 1 is embedded in the surface of the carrier 6. For this purpose a recess was structured into the carrier 6, a silicon wafer, using standard processes known in the microsystem technology such as etching. Using PECVD the filling material 2 was accumulated in the recess. In this way a very compact embodiment of the invention can be produced.

FIG. 3 shows an embodiment, where a cooling unit 8 is envisaged. This cooling unit 8 is located in a recess 9, which is structured into the carrier 6. As a result the cooling unit is separated by a relatively thin walled area 10 from the filling material 2 in the chamber 1, so that the transmission of cooling energy is optimized.

1-21. (canceled)

22. A miniaturized device for the storage and/or enrichment of molecules or atoms, or both, especially for a miniaturized gas chromatograph, characterized by a chamber with a filling material, the filling material comprising carbon nanotubes and/or carbon nanofibers, and wherein the filling material is covered by at least one layer of amorphous carbon, thus forming the chamber, and wherein the chamber comprises an inlet and an outlet for the delivery and extraction of a sample of molecules or atoms, or both.

23. The miniaturized device according to claim 22 characterized in that the filling material is porous.

24. The miniaturized device according to claim 22 characterized in that the chamber is formed on a carrier.

25. The miniaturized device according to claim 24 characterized in that the chamber is located on the surface of a carrier or that it is embedded in the surface of the carrier.

26. The miniaturized device according to claim 24 characterized in that the carrier is a silicon wafer.

27. The miniaturized device according to claim 22 characterized in that a heating unit is provided.

28. The miniaturized device according to claim 27 characterized in that the heating unit is located opposite to the side of the surface of the carrier with the chamber.

29. The miniaturized device according to claim 27, characterized in that the heating unit comprises a resistive heating element produced via thick-film or thin-film technology.

30. The miniaturized device according to claim 22 characterized in that a cooling unit is provided.

31. The miniaturized device according to claim 30 characterized in that the cooling unit comprises a Peltier-element.

32. The miniaturized device according to claim 30 characterized in that the cooling unit is located opposite to the side of the surface of the carrier with the chamber.

33. The miniaturized device according to claim 32 characterized in that the cooling unit is located in a recess of the carrier.

34. The miniaturized device according to claim 22, characterized in that the chamber is formed in a shape of a channel.

35. The miniaturized device according to claim 22 characterized in that the outlet can be connected to the inlet of a separation column.

36. A process for the production of a miniaturized device for the storage and/or enrichment of molecules or atoms, or both, especially for a miniaturized gas chromatograph, characterized by the following steps:
a) Deposition of at least one layer of filling material, which comprises nanoscale carbon nanotubes, carbon nanofibers and/or fullerenes on to a carrier and
b) Covering of said at least one layer of filling material with at least one layer of amorphous carbon,
whereby the layer of filling material and the layer of amorphous carbon are deposited in such a way onto the carrier that a channel is formed between the carrier and the layer of amorphous carbon, the channel containing the filling material, and whereby two openings are structured into the carrier which can be used to connect the channel to the outside world.

37. The process according to claim 36 characterized in that the layer of filling material and the layer of amorphous carbon are deposited via Plasma Enhanced Chemical Vapor Deposition (PECVD).

38. The process according to claim 36 characterized in that the area of the carrier, where the layer of filling material is deposited, is predefined by a catalyst layer of structured transition metal, previously deposited on the carrier.

39. The process according to claim 38 characterized in that iron, nickel or cobalt is used as the transition metal.

40. The process according to claim 36 characterized in that a silicon wafer is used as a carrier.

41. A method for the storage and/or enrichment of molecules or atoms, or both, for the purpose of analysis of the molecules or atoms wherein said method utilizes a miniaturized device characterized by a chamber with a filling material, the filling material comprising carbon nanotubes and/or carbon nanofibers, and wherein the filling material is covered by at least one layer of amorphous carbon, thus forming the chamber, and wherein the chamber comprises an inlet and an outlet for the delivery and extraction of a sample of molecules or atoms, or both.

42. The method according to claim 41 characterized in that molecules or atoms are stored and/or enriched from a fluid stream.

43. The method according to claim 42 where said fluid stream is a gas stream.
